(19) United States
(12) Patent Application Publication
(10) Pub. No.: US 2020/0159863 A1
(43) Pub. Date: May 21, 2020

(54) MEMORY NETWORKS FOR FINE-GRAIN OPINION MINING

(71) Applicant: SAP SE, Walldorf (DE)

(72) Inventors: Wenya Wang, Singapore (SG); Daniel Dahlmeier, Singapore (SG); Sinno Jialin Pan, Singapore (SG)

(21) Appl. No.: 16/196,008

(22) Filed: Nov. 20, 2018

(51) Int. Cl. G06F 17/30; G06F 17/27

(52) U.S. Cl. CPC G06F 17/30867; G06F 17/3069; G06F 17/30707; G06F 17/277

(57) ABSTRACT

Methods, systems, and computer-readable storage media for receiving input data including a set of sentences, each sentence including computer-readable text as a sequence of tokens, providing a memory network with coupled attentions (MNCA), the coupled attentions including an aspect attention and an opinion attention that are coupled by tensor operators for each sentence in the set of sentences, processing the input data through the MNCA to identify a set of aspect terms, and a set of opinion terms, and simultaneously assign a category to each aspect term and each opinion term from a set of categories, and outputting the set of aspect terms with respective categories, and the set of opinion terms with respective categories.

### BACKGROUND

Data analytics seeks to process large amounts of data to extract useful, and actionable information. For example, a corpus of data can include electronic documents that record user opinions about a variety of topics, and subjects (e.g., user reviews published on Internet websites, or social media). Data analytics processes have included sentiment analysis, and opinion mining. Relative to sentiment analysis, opinion mining can be described as fine-grained as it provides richer information as compared with coarse-grained sentiment analysis.

In opinion mining, traditional techniques focus on extraction of aspect terms and opinion terms, and utilizing the syntactic relations among the words given by a dependency parser. These approaches, however, require additional information, and highly depend on the quality of the parsing results. As a result, they may perform poorly on user-generated texts, such as product reviews, tweets, and the like, whose syntactic structure is not precise.

### SUMMARY

Implementations of the present disclosure are directed to opinion mining. More particularly, implementations of the present disclosure are directed to memory networks with coupled attentions for opinion mining.

In some implementations, actions include receiving input data including a set of sentences, each sentence including computer-readable text as a sequence of tokens, providing a memory network with coupled attentions (MNCA), the coupled attentions including an aspect attention and an opinion attention that are coupled by tensor operators for each sentence in the set of sentences, processing the input data through the MNCA to identify a set of aspect terms, and a set of opinion terms, and simultaneously assign a category to each aspect term and each opinion term from a set of categories, and outputting the set of aspect terms with respective categories, and the set of opinion terms with respective categories. Other implementations of this aspect include corresponding systems, apparatus, and computer programs, configured to perform the actions of the methods, encoded on computer storage devices.

These and other implementations can each optionally include one or more of the following features: the tensor operators model complex token interactions; the aspect attention provides a likelihood that each token of a respective sentence is an aspect term, and the opinion attention provides a likelihood that each token of the respective sentence is an opinion term; each of the aspect attention and the opinion attention learns a prototype vector, a token-level feature vector, and a token-level attention score for each word in a sentence, the token-level feature vector and the token-level attention score representing an extent of correlation between each token and the prototype vector through a tensor operator; the tensor operators are provided as a set of aspect tensor operators, and a set of opinion tensor operators for each category in the set of categories; each token-level label comprises one of beginning of an aspect, inside of an aspect, beginning of an opinion, inside of an opinion, and none; and a multi-task memory network (MTMN) includes the MNCA, a shared tensor decomposition to model commonalities of syntactic relations among different categories by sharing the tensor parameters, context-aware multi-task feature learning to jointly learn features among categories by constructing context-aware task similarity matrices, and an auxiliary task to predict overall sentence-level category labels to assist token-level prediction tasks.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts a dependency example for the features of memory networks with coupled attentions (MNCA) in accordance with implementations of the present disclosure.

FIG. 3 depicts an example architecture of dual propagation memory networks for aspect term and opinion term extraction in accordance with implementations of the present disclosure.

FIGS. 4A and 4B respectively depict independent attentions and coupled attentions with tensor operator in accordance with implementations of the present disclosure.

FIG. 5 depicts an example architecture of each non-output layer used in multi-task memory networks (MTMNs) in accordance with implementations of the present disclosure.

FIG. 6 depicts an example architecture of an output layer used in MTMNs in accordance with implementations of the present disclosure.

FIG. 7 depicts an example process that can be executed in accordance with implementations of the present disclosure.

FIG. 8 is a schematic illustration of example computer systems that can be used to execute implementations of the present disclosure.

Like reference symbols in the various drawings indicate like elements.

### DETAILED DESCRIPTION

Implementations of the present disclosure are directed to opinion mining. More particularly, implementations of the present disclosure are directed to memory networks with coupled attentions for opinion mining. Implementations can include actions of receiving input data including a set of sentences, each sentence including computer-readable text as a sequence of tokens, providing a memory network with coupled attentions (MNCA), the coupled attentions including an aspect attention and an opinion attention that are coupled by tensor operators for each sentence in the set of sentences, processing the input data through the MNCA to identify a set of aspect terms, and a set of opinion terms, and simultaneously assign a category to each aspect term and each opinion term from a set of categories, and outputting the set of aspect terms with respective categories, and the set of opinion terms with respective categories.

In general, and as described in further detail herein, implementations of the present disclosure provide an opinion mining service that uses an end-to-end deep learning model for fine-grain opinion mining without any preprocessing. In accordance with implementations of the present disclosure, the model includes a memory network that automatically learns complicated interactions among aspect terms (e.g., words, phrases), and opinion terms (e.g., words, or phrases) within a corpus of computer-readable text. In some examples, an aspect term can include a single word, or multiple words (phrase). In some examples, an opinion term can include a single word, or multiple words (phrase). In some implementations, the memory network is extended in a multi-task manner to identify aspect terms, and opinion terms within each sentence, as well as simultaneous categorization of the identified terms. In some implementations, an end-to-end multi-task memory network is provided, where extraction of aspect terms, and opinion terms for a specific category is considered as a task, and all of the tasks are learned jointly by exploring commonalities and relationships among them.

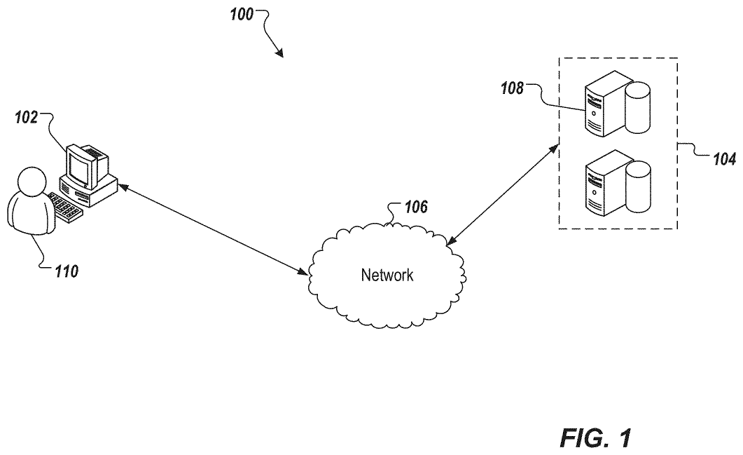

FIG. 1 depicts an example architecture 100 that can be used to execute implementations of the present disclosure. In the depicted example, the example architecture 100 includes one or more client devices 102, a server system 104, and a network 106. The server system 104 includes one or more server devices 108. In the depicted example, a user 110 interacts with the client device 102. In an example context, the user 110 can include a user, who interacts with an application that is hosted by the server system 104.

In some examples, the client device 102 can communicate with one or more of the server devices 108 over the network 106. In some examples, the client device 102 can include any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices.

In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, each server device 108 includes at least one server and at least one data store. In the example of FIG. 1, the server devices 108 are intended to represent various forms of servers including, but not limited to a web server, an application server, a proxy server, a network server, and/or a server pool. In general, server systems accept requests for application services and provides such services to any number of client devices (e.g., the client device 102) over the network 106.

In accordance with implementations of the present disclosure, the server system 104 can host a multi-document summarization service (e.g., provided as one or more computer-executable programs executed by one or more computing devices). For example, input data (text data, secondary data) can be provided to the server system (e.g., from the client device 102), and the server system can process the input data through an opinion mining service to provide result data. For example, the server system 104 can send the result data to the client device 102 over the network 106 for display to the user 110. In some examples, the input data is provided as a corpus of computer-readable text data (e.g., user reviews of products/services), and the result data is provided as a structured summary of the input data.

To provide further context for implementations of the present disclosure, in fine-grain opinion mining, aspect-based analysis aims to provide fine-grained information through token-level predictions. In some examples, an aspect term refers to a word, or a phrase describing some feature of an entity (e.g., a product, a service). In some examples, an opinion term refers to the expression carrying subjective emotions. For example, in the sentence “The soup is served with nice portion, the service is prompt,” soup, portion and service are aspect terms, while nice and prompt are opinion terms. As introduced above, traditional approaches focus on extracting aspect terms due to the absence of opinion term annotations in large-scale datasets. However, opinion terms play an important role in fine-grain opinion mining in order to achieve structured review summarization.

In some traditional approaches, the opinion targets are mined through pre-defined rules based on syntactic or dependency structure of each sentence. In some examples, extensive feature engineering is applied to build a classifier from an annotated corpus to predict a label (e.g., aspect, opinion, others) on each token in each sentence. These two categories of approaches are labor-, and resource-intensive for constructing rules or features using linguistic and syntactic information. To reduce the engineering effort, deep-learning-based approaches have been proposed to learn high-level representations for each token, on which a classifier can be trained. Despite some promising results, most deep-learning approaches still require a parser analyzing the syntactic/dependency structure of the sentence to be encoded into the deep-learning models. In this case, the performances might be affected by the quality of the parsing results.

More recent approaches have used convolutional neural networks (CNNs), or recurrent neural networks (RNNs). However, without the syntactic structure, CNN can only learn general contextual interactions within a specified window size without focusing on the desired propagation between aspect terms and opinion terms. It is also challenging to extract the prominent features corresponding to aspects or opinions from convolutional kernels. RNNs are even weaker to capture skip connections among syntactically-related words. Further, and in practice, the dependency structures of many user-generated texts may not be precise with a computational parser, especially in informal texts, which may degrade the performances of existing approaches.

In view of the above context, implementations of the present disclosure use an attention mechanism with tensor operators in a memory network to replace the role of dependency parsers, and automatically capture the relations among tokens in each sentence. Specifically, implementations of the present disclosure provide coupled attentions, one for aspect extraction, and the other for opinion extraction. In some implementations, the attentions are learned interactively, such that label information can be dually propagated among aspect terms, and opinion terms by exploiting their relations. Further, implementations of the present disclosure use a memory network to explore multiple layers of the coupled attentions in order to extract inconspicuous aspect/opinion terms.

In accordance with implementations of the present disclosure, the extraction task is extended to category-specific extraction of aspect terms, and opinion terms extraction, where aspect/opinion terms are simultaneously extracted and classified to a category from a pre-defined set. In this manner, a more structured opinion output can be provided. Further, this is beneficial for linking aspect terms and opinion terms through their category information. Continuing with the above example, the objective is to extract and classify soup and portion as aspect terms under the “DRINKS” category, and service as an aspect term under the “SERVICE” category, similar for the opinion terms nice and prompt.

Traditional approaches only focus on categorization of aspect terms, where aspect terms are extracted in advance, and the goal is to classify them into one of the predefined categories. In contrast, the joint task of the present disclosure is much more challenging and has rarely been investigated. This is because, when specific categories are taken into consideration for term extraction, training data becomes extremely sparse (e.g. certain categories may only contain very few reviews or sentences). Moreover, the joint task achieves both extraction and categorization, simultaneously, which significantly increases the difficulty compared with the task of only extracting overall aspect/opinion terms, or classifying pre-extracted terms. Although topic models can achieve both grouping and extraction at the same time, they mainly focus on grouping, and could only identify general and coarse-grained aspect terms.

In view of this, and as described in further detail herein, implementations of the present disclosure provide an end-to-end deep multi-task learning architecture. In accordance with implementations of the present disclosure, term extraction is provided for each specific category as an individual task, where the above-introduced memory network is used for co-extracting aspect terms, and opinion terms. The memory networks are then jointly learned in a multi-task learning manner to address the data sparsity issue of each task. Accordingly, implementations of the present disclosure provide an end-to-end memory network for co-extraction of aspect terms, and opinion terms without requiring any syntactic/dependency parsers or linguistic resources to generate additional information as input. Further, implementations of the present disclosure extend the memory network with a multi-task mechanism to address provide category-specific aspect term, and opinion term extraction.

As introduced above, implementations of the present disclosure process input data provided as a corpus of computer-readable text (e.g., user reviews of products/services) to provide result data, which includes a structured summary. In some examples, the input data includes sentences. In some examples, a sentence can be dentoed as a sequence of tokens (words) sᵢ={wᵢ₁, wᵢ₂, . . . , wᵢₙ_{ᵢ}}, and can be represented as a D×nᵢ matrix Xᵢ=[xᵢ₁, . . . , xᵢₙ_{ᵢ}], where xᵢⱼ∈R^{D} is a feature vector for the j-th token of the sentence. For fine-grained aspect term, and opinion term extraction, the expected output is a sequence of token-level labels yᵢ=(yᵢ₁, yᵢ₂, . . . , yᵢₙ_{ᵢ}), where each yᵢⱼ∈{BA, IA, BP, IP, O} that represents beginning of an aspect, inside of an aspect, beginning of an opinion, inside of an opinion, or none of the above.

In some implementations, a subsequence of labels started with “BA” and followed by “IA” indicates a multi-word aspect term, similar for opinion terms. For the finer-grained terms extraction, the category information is considered, where [symbol] ={1, 2, . . . , C} denotes a predefined set of C categories, and c∈ [symbol] is an entity/attribute type, (e.g., “DRINK # QUALITY” is a category in the restaurant domain). A superscript c denotes the category-related variable. In some examples, yᵢ^{c}∈Rⁿ^{ᵢ}, where yᵢⱼ^{c}∈{BA_{c}, IA_{c}, BP_{c}, IP_{c}, O_{c}} is the label of the j-th token. Here, BA_{c} and IA_{c} refer to beginning of aspect and inside of aspect, respectively, of category c, similar for BP_{c}, IP_{c} and O_{c}. In the following discussion, j is used to denote the index of a token in a sentence, c is sued to denote the association with category c and for simplifying notations. In some examples, the sentence index i is omitted, if the context is clear.

As introduced above, to fully exploit the syntactic relations among different tokens in a sentence, most existing methods apply a computational parser to analyze the syntactic/dependency structure of each sentence in advance, and use the relations between aspects and opinions to double propagate the information. One major limitation is that the generated relations are deterministic, and fail to handle uncertainty underlying the data. This is compounded by the fact that grammar and syntactic errors commonly exist in user-generated texts, in which case the outputs of a dependency parser may not be precise, and thus degrades the performance. To avoid this, implementations of the present disclosure provide a memory network with coupled attentions to automatically learn the relations between aspect terms, and opinion terms without any linguistic knowledge.

To further explore category information for each aspect term, and opinion term, one straightforward solution is to apply the extraction model to identify general aspect terms, and opinion terms first, and then post-classify them into different categories using an additional classifier. However, this pipeline approach may suffer from error propagation from the extraction phase to the classification phase. An alternative solution is to train an extraction model for each category c independently, and then combine the results of all the extraction models to generate final a prediction. However, in this way, for each fine-grained category, aspect terms, and opinion terms become extremely sparse for training, which makes it difficult to learn a precise model for each category.

To address the above issues, implementations of the present disclosure model the problem in a multi-task learning manner, where aspect term, and opinion term extraction for each category is considered as an individual task, and an end-to-end deep learning architecture is developed to jointly learn the tasks by exploiting their commonalities and similarities. The multi-task model of the present disclosure is referred to as multi-task memory networks (MTMNs). It can be noted that memory networks with coupled attentions (MNCAs) are a component of MTMNs.

In some implementations, a MNCA includes, for each sentence, constructing a pair of attentions. In some examples, an aspect attention is provided for aspect term extraction, and an opinion attention is provided for opinion term extraction. Each of the attentions aims to learn a general prototype vector, a token-level feature vector, and a token-level attention score for each word in the sentence. The feature vector and attention score measure the extent of correlation between each input token and the prototype through a tensor operator, where a token with a higher score indicates a higher chance of being an aspect or opinion.

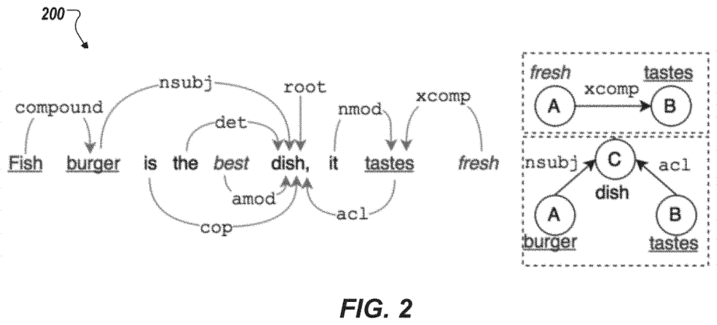

In some examples, the MNCA captures direct relations between aspect terms, and opinion terms. FIG. 2 depicts a dependency example 200 for the features captures by a MNCA in accordance with implementations of the present disclosure. For example, and as depicted in FIG. 2,

$$A {}^{xcomp} B$$

is a direct relation between an aspect term, and an opinion term. In some examples, the aspect attention, and the opinion attention are coupled in learning such that the learning of each attention is affected by the other. This helps to double-propagate information between them.

In some examples, the MNCA captures indirect relations among aspect terms, and opinion terms. For example,

$$A {}^{nsubj} C {}^{acl} B$$

is an indirect relation that is captured. In some examples, the memory network is constructed with multiple layers to update the learned prototype vectors, feature vectors, and attention scores to better propagate label information for co-extraction of aspect terms, and opinion terms.

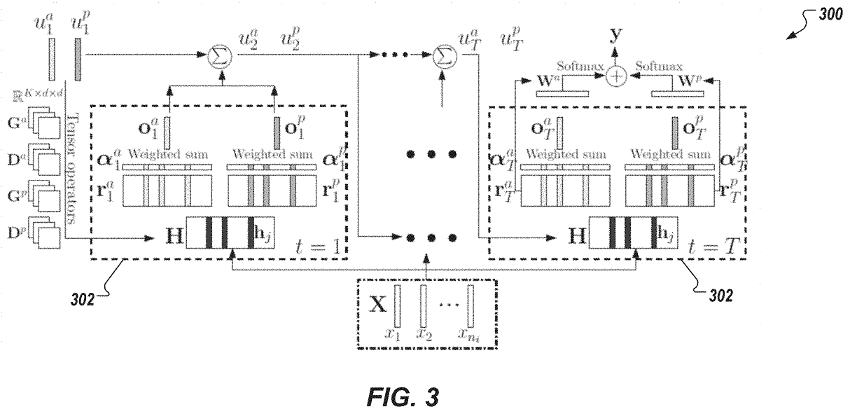

FIG. 3 depicts an example architecture 300 of dual propagation memory networks for aspect term and opinion term extraction in accordance with implementations of the present disclosure. In the example of FIG. 3, the example architecture 300 includes a plurality of blocks 302. Each block includes the computation of a single layer with the shared input X, and four 3-dimensional tensors {G^{a}, D^{a}, G^{p}, D^{p}}.

In further detail, and as introduced above, a basic unit of the MNCA is the pair of attentions: the aspect attention and the opinion attention. Different from traditional attentions, which are used for generating a weighted sum of the input to represent the sentence-level information, the aspect attention and the opinion attention are used to identify the possibility of each token being an aspect term, or an opinion term, respectively.

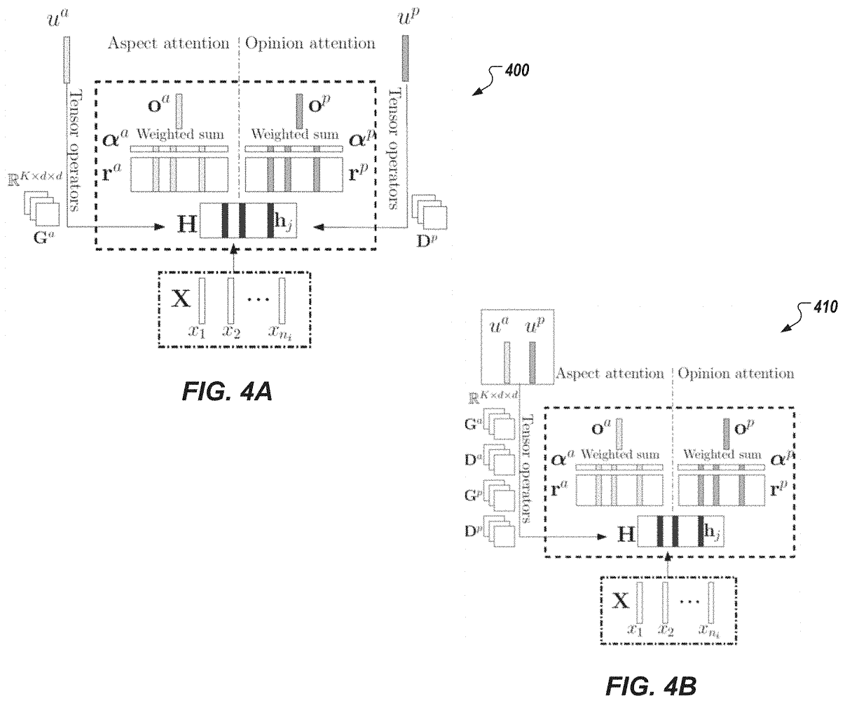

FIGS. 4A and 4B respectively depict independent attentions 400, and coupled attentions with tensor operator 410 in accordance with implementations of the present disclosure. As shown in FIGS. 4A and 4B, given a sentence with pre-trained word embeddings X=[x₁, . . . , xₙ_{ᵢ}], apply Gated Recurrent Unit (GRU) is applied to obtain a memory matrix H=[h₁, . . . , hₙ_{ᵢ}], where hⱼ∈R^{d} is a feature vector for j-th token considering its context. In the aspect attention, a prototype vector u^{a} is generated, which can be viewed as a general feature representation for aspect terms. This aspect prototype aims to guide the model to attend to the most relevant tokens (most likely aspect words). In some examples, u^{a} is randomly initialized from a uniform distribution: u^{a}˜U[−0.2,0.2]∈R^{d}, which is trained and updated iteratively. Given u^{a} and H, the model scans the input sequence, and computes an attention vector rⱼ^{a} and an attention score αⱼ^{a} for the j-th token. To obtain rⱼ^{a}, a composition vector βⱼ^{a}∈R^{K} that encodes the extent of correlations between hⱼ and the prototype vector u^{a} through a tensor operator is computed. For example:

βⱼ^{a}=tan h(hⱼ^{T}G^{a}u^{a}) (1)

where G^{a}∈R^{K×d×d} is a 3-dimensional tensor.

In some examples, a tensor operator could be viewed as multiple bilinear matrices that model more complicated compositions between two units. Here, G^{a} could be decomposed into K slices, where each slice Gₐ^{k}∈R^{d×d} is a bilinear term that interacts with two vectors, and captures one type of composition (e.g., a specific syntactic relation). Consequently, hⱼ^{T}G^{a}u^{a}∈R^{K} inherits K different kinds of compositions between hⱼ and u^{a} that indicates complicated correlations between each input token and the aspect prototype. Then rⱼ^{a} is obtained from βᵢ^{a} via a GRU network:

rⱼ^{a}=(1−zⱼ^{a})erⱼ₋₁^{a}+zⱼ^{a}e\tilde{r}ⱼ^{a} (2)

where

gⱼ^{a}=σ(W_{g}^{a}rⱼ₋₁^{a}+U_{g}^{a}βⱼ^{a}),

zⱼ^{a}=σ(W_{z}^{a}rⱼ₋₁^{a}+U_{z}^{a}βⱼ^{a}),

\tilde{r}ⱼ^{a}=tan h(Wᵣ^{a}(gⱼ^{a}erⱼ₋₁^{a})+Uᵣ^{a}βⱼ^{a}).

This helps to encode sequential context information into the attention vector rⱼ^{a}∈R^{K}. Many aspect terms consist of multiple tokens, and exploiting context information is helpful for making predictions. For simplicity, rⱼ^{a}=GRU (βⱼ^{a}, θ^{a}), where θ^{a}={W_{g}^{a}, U_{g}^{a}, W_{z}^{a}, U_{z}^{a}, Wᵣ^{a}, Uᵣ^{a}} to denote (2). An attention score αⱼ^{a} for token wⱼ is computed as:

$${α}_{j}^{a} = \frac{exp ( {e}_{j}^{a} )}{{\sum }_{k} exp ( {e}_{k}^{a} )} , \qquad ( 3 )$$

where αⱼ^{a} denotes the j-th element of the vector α^{a}, similar for eⱼ. Here eⱼ^{a}=(v^{a}, rⱼ^{a}). Since rⱼ^{a} is a correlation feature vector, v^{a}∈R^{K} can be deemed as a weight vector that weighs each feature accordingly. In this manner, αⱼ^{a} becomes the normalized score, where a higher score indicates a higher correlation with the prototype, and a higher chance of being attended. The procedure for opinion attention is similar. In the subsequent sections, a superscript p is used to denote the opinion attention.

As introduced above, an issue for co-extraction of aspect terms and opinion terms is how to fully exploit the relations between aspect terms and opinion terms, such that the information can be propagated to each other to assist final predictions. However, independently learning of the aspect attention and the opinion attentions fails to utilize their relations. Accordingly, implementations of the present disclosure couple the learning of the two attentions, such that information of each attention can be dually propagated to the other.

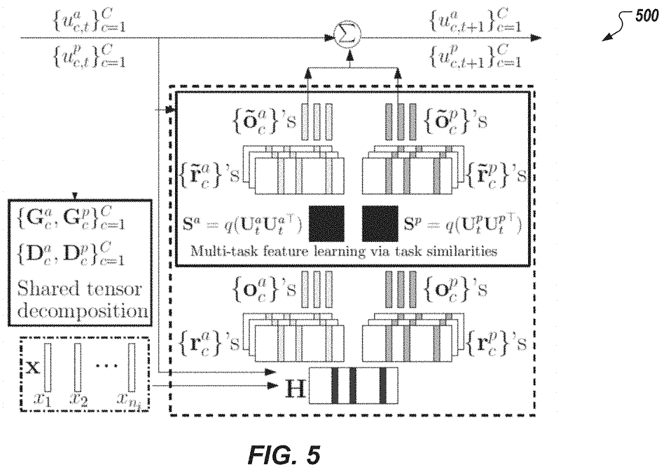

FIG. 5 depicts an example architecture 500 of each non-output layer used in MTMNs in accordance with implementations of the present disclosure. As depicted in FIG. 5, instead of a single attention, the prototype to be fed into each attention module becomes a pair of vectors {u^{a}, u^{p}}, and the tensor operator in (1) becomes a set of tensors {G^{a}, D^{a}, G^{p}, D^{p}}. The composition vectors βⱼ^{a} and βⱼ^{p} are computed as:

βⱼ^{a}=tan h([hⱼ^{T}G^{a}u^{a}:hⱼ^{T}D^{a}u^{p}]), and βⱼ^{p}=tan h([hⱼ^{T}G^{p}u^{a}:hⱼ^{T}D^{p}u^{p}]) (4)

where [:] denotes concatenation of two vectors. Intuitively, G^{a} or D^{p} is to capture the K syntactic relations within aspect terms or opinion terms themselves, while G^{p} and D^{a} are to capture syntactic relations between aspect terms and opinion terms for dual propagation. It can be noted that βⱼ^{a} and βⱼ^{p}, both of which are of 2K dimensions, go through the same procedure as (2) and (3) to produce rⱼ^{a}, rⱼ^{p}∈R^{2K} as the hidden representations for hⱼ with respect to the aspect attention and the opinion attention, respectively.

In some implementations, a single layer with the coupled attentions is able to capture the direct relations between aspect terms and opinion terms, but fails to exploit the indirect relations among them, such as the

$$A {}^{nsubj} C {}^{acl} B$$

relation shown in FIG. 2. To address this issue, implementations of the present disclosure integrate the coupled attentions into a memory network, such that the information learned from the attentions could be updated and used for better extraction. The memory network includes multiple layers of coupled attentions. For each layer t+1 as shown in FIG. 3, the prototype vectors uₜ₊₁^{a} and uₜ₊₁^{p} are updated based on the prototype vectors in the previous layer uₜ^{a} and uₜ^{p} to incorporate more feasible representations for aspect terms or opinion terms through:

uₜ₊₁^{a}=tan h(Q^{a}uₜ^{a})+oₜ^{a}, and uₜ₊₁^{p}=tan h(Q^{p}uₜ^{p})+oₜ^{p} (5)

where Q^{a}, Q^{p}∈R^{d×d} are recurrent transformation matrices to be learned, and oₜ^{a}, oₜ^{p} are accumulated vectors computed as:

oₜ^{a}=Σⱼαₜ^{a}hⱼ, and oₜ^{p}=Σⱼαₜ^{p}hⱼ (6)

Intuitively, oₜ^{a} and oₜ^{p} are dominated by the input feature vectors {hⱼ}'s with higher attention scores. Therefore, oₜ^{a} and oₜ^{p} tend to approach to the attended feature vectors of aspect or opinion words. In this manner, uₜ₊₁^{a} (or uₜ₊₁^{p}) incorporates the most probable aspect (or opinion) terms, which in turn will be used to interact with {hᵢ}'s at layer t+1 to learn more precise token representations and attention scores, and sentence representations for selecting other non-obvious target tokens. At the last layer T, after generating all the {r_{T,j}^{a}}'s and {r_{T,j}^{p}}'s, two 3-dimensional label vectors yⱼ^{a}, and yⱼ^{p} are computed as:

yⱼ^{a}=softmax(W^{a}r_{T,j}^{a}), and yⱼ^{p}=softmax(W^{p}r_{T,j}^{p}) (7)

where W^{a}, W^{p}∈R^{3×2K} are transformation matrices for the predictions on aspects and opinions, respectively, and yⱼ^{a} denotes the probabilities of hⱼ being BA, IA and O, while yⱼ^{p} denotes the probabilities of hⱼ being BP, IP and O. For training, the loss function can be provided as:

[symbol]

=Σⱼ₌₁ⁿ^{ᵢ}Σ_{m∈{a,p}}l(ŷⱼ^{m},yⱼ^{m}) (8)

where l(·) is the cross-entropy loss, and ŷⱼ^{m}∈R³ is a one-hot vector representing the ground-truth label for the j-th token with respect to aspect or opinion. For testing or making predictions, the final label for each token j is produced by comparing the values in yⱼ^{a} and yᵢ^{p}. If both of them are O, then the label is O. If only one of them is O, the other is selected as the label. Otherwise, the label is the value with the largest value.

In accordance with implementations of the present disclosure, the proposed memory network is able to attend to relevant words that are highly interactive given the prototypes. This is achieved by tensor interactions, for example, hⱼTG^{a}uₜ^{a} between jth word and the aspect prototype. By updating the prototype vector uₜ₊₁^{a} with extracted information from the tth layer, the following is provided:

uₜ₊₁^{a}=tan h(Q^{a}uₜ^{a})+Σⱼαₜ^{a}hⱼ (9)

where highly interactive hⱼ contributes more to the prototype updates. Since the final feature representation r_{T,j}^{a} for each word is generated from the above tensor interactions, it transforms the normal feature space hⱼ to interaction space r_{T,j}, compared to simple RNNs that only computes hⱼ.

Compared with a RNN, where the final feature representation for each word is generated from the composition with the child nodes in a dependency tree, the memory network of the present disclosure avoids the construction of dependency trees and is not prone to parsing errors. For example, if the final feature for jth word is denoted as h′ⱼ for the RNN, then h′ⱼ=f(Wᵥ·xⱼ+b+ [symbol] Wᵣ_{ⱼₖ}·hₖ). Here [symbol] ⱼ denotes the set of children for node j, and Wᵣ_{ⱼₖ} represents the transformation matrix for each dependency relation rⱼₖ between jth node and its child. In this case, an incorrect relation parsing will lead to different Wᵣ_{ⱼₖ} or hₖ, resulting in possibly erroneous hidden representations. The memory network of the present disclosure, on the other hand, does not require pre-defined composition nodes. The attention mechanism in the previous layer will automatically select relevant words to make interactions.

In accordance with implementations of the present disclosure, the MNCA is extended to deal with category-specific extraction of aspect terms and opinion terms by integrating the multi-task learning strategy. In some implementations, the multi-task memory network includes: a category-specific MNCA to co-extract aspect and opinion terms for each category, a shared tensor decomposition to model the commonalities of syntactic relations among different categories by sharing the tensor parameters, context-aware multi-task feature learning to jointly learn features among categories through constructing context-aware task similarity matrices, and an auxiliary task to predict overall sentence-level category labels to assist token-level prediction tasks.

With regard to the category-specific MNCA implementations of the present disclosure use MNCA as the base classifier in MTMN for co-extraction of aspect terms and opinion terms for each category c. The procedure of MNCA is applied for each category c by denoting each variable with the subscript c:

β_{c[j]}^{a}=tan h([hⱼ^{T}G_{c}^{a}u_{c}^{a}:hⱼ^{T}D_{c}^{a}u_{c}^{p}]), and β_{c[j]}^{p}=tan h([hⱼ^{T}G_{c}^{p}u_{c}^{a}:hⱼ^{T}D_{c}^{p}u_{c}^{p}]) (10)

where G_{c}^{a}, G_{c}^{p}, D_{c}^{a}, D_{c}^{p}∈R^{K×d×d}, and r_{c[j]}^{a} and r_{c[j]}^{p} are obtained as the hidden representations for hⱼ with respect to aspect and opinion of category c, respectively. Normalized attention scores for hⱼ for each category c are computed as:

$${α}_{c [ j ]}^{a} = \frac{exp ( {e}_{c [ j ]}^{a} )}{{\sum }_{k} exp ( {e}_{c [ k ]}^{a} )} , and {α}_{c [ j ]}^{p} = \frac{exp ( {e}_{c [ j ]}^{p} )}{{\sum }_{k} exp ( {e}_{c [ k ]}^{p} )} \qquad ( 11 )$$

The overall representations of the sentence for category c in terms of aspects and opinions, denoted by o_{c}^{a} and o_{c}^{p}, respectively, are computed using (6), which will be further used to produce the prototype vectors u_{c,t+1}^{a}, u_{c,t+1}^{p} in the next layer using (5). At the last layer T, after generating all {r_{c[j]}^{a}}'s and {r_{c[j]}^{p}}'s, for each category c, the two 3-dimensional label vectors y_{c[j]}^{a} and y_{c[j]}^{p} are computed as:

y_{c[j]}^{a}=softmax(W^{a}r_{c[j]}^{a}), and y_{c[j]}^{p}=softmax(W^{p}r_{c[j]}^{p}) (12)

For training, the loss function can be defined as:

[symbol]

ₜₒₖ=Σ_{c}Σⱼ₌₁ⁿ^{ᵢ}Σ_{m∈{a,p}} [symbol] (ŷ_{c[j]}^{m},y_{c[j]}^{m}) (13)

where [symbol] (·) is the cross-entropy loss. For testing, a label is generated for each token j. In [symbol] some examples, a label y_{c[j]} is provided for category c on the j-th token by comparing the largest value in y_{c[j]}^{a} and y_{c[j]}^{p} using the same method as MNCA. The final label is provided on the j-th token by integrating y_{c[j]}'s across all the categories.

If the above formulation is directly applied to extract aspect terms and opinion terms for each category independently, the result is not satisfactory. This is because training data for each specific category becomes too sparse to learn precise predictive models if extractions for different categories are considered independently. In view of this, and as described in further detail herein, multi-task learning techniques and MNCA are incorporated into a unified memory network to make aspect and opinion terms co-extraction effective.

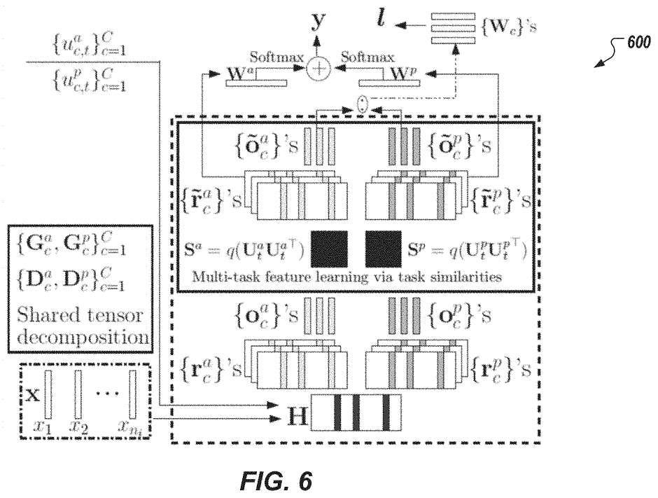

As described above, for each category c, there are four tensor operators G_{c}^{a}, G_{c}^{p}, D_{c}^{a}, and D_{c}^{p} to model the complex token interactions, each of which is in R^{K×d×d} When the number of categories increases, the parameter size may be very large. As a result, available training data may be too sparse to estimate the parameters precisely. Therefore, instead of learning the tensors for each category independently, implementations of the present disclosure assume that interactive relations among tokens are similar across categories. Accordingly, implementations of the present disclosure learn a low-rank shared information among the tensors through collective tensor factorization. This is depicted in FIG. 6, which provides an example architecture 600 of an output layer used in MTMNs in accordance with implementations of the present disclosure.

In some implementations, G^{a}∈R^{C×K×d×d} is the concatenation of all of the {G_{c}^{a}}'s, and denote by Gₖ^{a}=G^{a}_{[·,k,·,·]}∈R^{C×d×d} the collection of k-th bi-linear interaction matrices across C tasks for the aspect attention. The same also applies to G^{p} and Gₖ^{p} for the opinion attention. Factorization is performed on each Gₖ^{a} and Gₖ^{p}, respectively, through:

Gₖ_{_{[c,·,·]}}^{a}=Zₖ_{_{[c,·]}}^{a} [symbol] ₖ^{a}, and Gₖ_{_{[c,·,·]}}^{p}=Zₖ_{_{[c,·]}}^{p} [symbol] ₖ^{a} (14)

where [symbol] ₖ^{a}, [symbol] ₖ^{p}∈R^{m×d×d} are shared factors among all the tasks with m<C, while Zₖ^{a}, Zₖ^{p}∈R^{C×m} with each row Zₖ_{_{[c,·]}}^{a} and Zₖ_{_{[c,·]}}^{p} being specific factors for category c. The shared factors can be considered as m latent basis interactions, where the original k-th bi-linear relation matrix Gₖ_{_{[c,·,·]}}^{a} (or Gₖ_{_{[c,·,·]}}^{p}) for c is the linear combination of the latent basis interactions. The same approach also applies to the tensors {D_{c}^{a}}'s and {D_{c}^{p}}'s. In this manner, the parameter dimensions are reduced by enforcing sharing within a small number of latent interactions.

With regard to context-aware multi-task feature learning, besides jointly decomposing tensors of syntactic relations across categories, implementations of the present disclosure exploit similarities between categories (also referred to as tasks) to learn more powerful features for each token and each sentence. Consider the following motivating example, “FOOD # PRICE” is more similar to “DRINK # PRICE” than “SERVICE # GENERAL” because the first two categories may share some common aspect/opinion terms, such as expensive. Therefore, by representing each task in a form of distributed vector, their similarities can be directly computed to facilitate knowledge sharing.

Based on this motivation, features \tilde{r}_{c}^{a} (or \tilde{r}_{c}^{p}) from r_{c}^{a} (or r_{c}^{p}) can be updated by integrating task relatedness. Specifically, at a layer t, suppose that u_{C,t}^{a}, and u_{C,t}^{p} are the updated prototype vectors passed from the previous layer. These two prototype vectors can be used to represent task c, because u_{C,t}a and u_{C,t}^{p} are learned interactively with the category-specific sentence representations o_{c}^{a}'s and o_{c}^{p}'s of the previous t−1 layers, respectively. In some examples, U^{a}, U^{p}∈R^{d×C} can denote the matrices consisting of u_{c}^{a} and u_{c}^{p} as a column vector, respectively, then the task similarity matrices, S^{a} and S^{p}, in terms of aspects and opinions can be computed as:

S^{a}=q(U^{aT}U^{a}), and S^{p}=q(U^{pT}U^{p}) (15)

where q(·) is the softmax function carried in a column-wise manner so that the similarity scores between a task and all the tasks sum up to 1. The similarity matrices S^{a} and S^{p} are used to refine feature representation of each token for each task by incorporating feature representations from related tasks:

\tilde{r}_{c,[j]}^{a}=Σ_{c′=1}^{C}S_{cc′}^{a}r_{c′,[j]}^{a}, and \tilde{r}_{c[j]}^{p}=Σ_{c′=1}^{C}S_{cc′}^{p}r_{c′[j]}^{p} (16)

where r_{c′,[j]}^{a} and r_{c′,[j]}^{p} denote the j-th column of the matrix r_{c′}^{a} and r_{c′}^{p}, respectively. Similarly, the feature representation of each sentence for each task is refined as follows:

õ_{c}^{a}=Σ_{c′=1}^{C}S_{cc′}^{a}o_{c′}^{a}, and õ_{c}^{p}=Σ_{c′=1}^{C}S_{cc′}^{p}o_{c′}^{p} (17)

Regarding the update of the prototype vectors, o_{c}^{a} and o_{c}^{p} are replaced by õ_{c}^{a} and õ_{c}^{p}, respectively. It can be noted that the feature sharing among different tasks is context-aware because U^{a} and U^{p} are category representations depending on each sentence. This means that different sentences might indicate different task similarities. For example, when cheap is presented, it might increase the similarity between “FOOD # PRICES” and “RESTAURANT # PRICES”. As a result, \tilde{r}_{c[j]}^{a} for task c could incorporate more information from task c′, if c′ has higher similarity score indicated by S_{cc′}^{a}.

With regard to the auxiliary task, as MTMN could produce sentence-level feature representations, to better address the data sparsity issue, implementations of the present disclosure use additional global information on categories in the sentence level. The following example can be considered: if it is known that the sentence “The soup is served with nice portion, the service is prompt” belongs to the categories “DRINKS # STYLE_OPTIONS” and “SERVICE # GENERAL”, it can be inferred that some words in the sentence should belong to one of these two categories. To make use of this information, an auxiliary task is constructed to predict the categories of a sentence.

In some implementations, from training data, sentence-level labels can be automatically obtained by integrating tokens' labels. Therefore, besides the token loss in (8) for the target token-level prediction task, the sentence loss for the auxiliary task is defined. It can be noted that the learning of the target task (terms extraction), and auxiliary task (multi-label classification on sentences) are not independent. On one hand, the global sentence information helps the attentions to select category-relevant tokens. On the other hand, if the attentions are able to attend to target terms, the output context representation will filter out irrelevant noise, which helps making a prediction on the overall sentence.

More particularly, and as depicted in FIG. 6, for category c, õ_{c}=[õ_{c}^{a}:õ_{c}^{p}]∈R^{2d} is provided as the final representation for the sentence, and the output is generated using the softmax function:

l_{c}=softmax(W_{c}õ_{c}) (18)

where W_{c}∈R^{2×2d}, and l_{c}∈R² indicates the probability of the sentence belonging to category c or not. The loss of the auxiliary task is defined as [symbol] ₛₑₙ=Σ_{c} [symbol] (\hat{l}_{c},l_{c}), where [symbol] (·) is the cross-entropy loss, and \hat{l}_{c}∈{0,1}² is the ground truth using one-hot encoding indicating whether category c is presented for the sentence. By incorporating the loss of the auxiliary task, the final objective for MTMN is written as [symbol] = [symbol] ₛₑₙ+ [symbol] ₜₒₖ, where [symbol] ₜₒₖ is defined in (8).

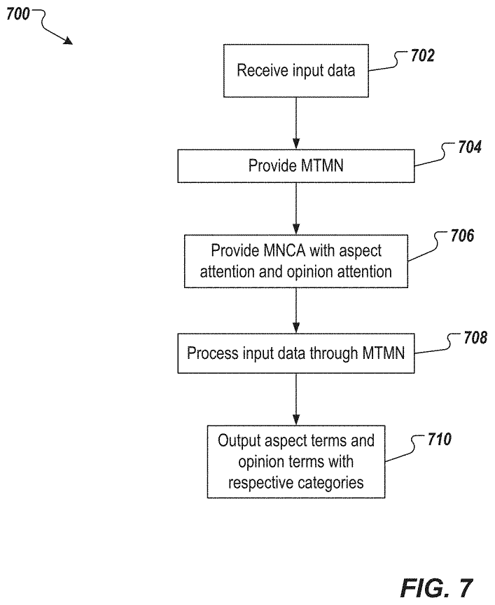

FIG. 7 depicts an example process 700 that can be executed in accordance with implementations of the present disclosure. In some examples, the example process 700 is provided using one or more computer-executable programs executed by one or more computing devices (e.g., the server system 104 of FIG. 1). Input data is received (702). For example, a corpus of text including a set of sentences is received. A MTMN is provided (704). A MNCA with aspect attentions and opinion attentions is provided (706). The input data is processed by the MTMN (708). A set of aspect terms and a set of opinion terms with respective categories are output (710).

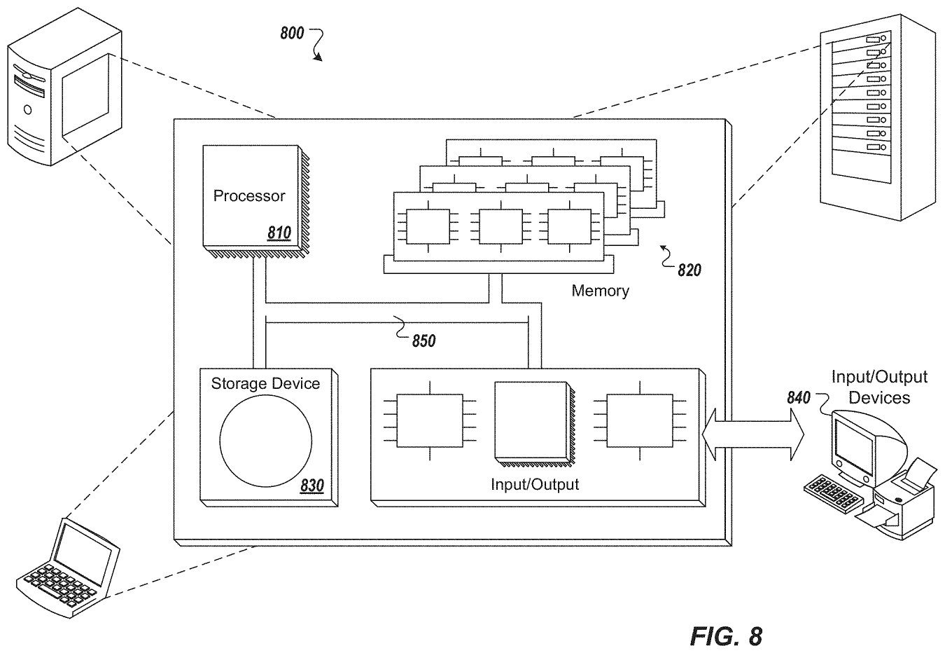

Referring now to FIG. 8, a schematic diagram of an example computing system 800 is provided. The system 800 can be used for the operations described in association with the implementations described herein. For example, the system 800 may be included in any or all of the server components discussed herein. The system 800 includes a processor 810, a memory 820, a storage device 830, and an input/output device 840. The components 810, 820, 830, 840 are interconnected using a system bus 850. The processor 810 is capable of processing instructions for execution within the system 800. In one implementation, the processor 810 is a single-threaded processor. In another implementation, the processor 810 is a multi-threaded processor. The processor 810 is capable of processing instructions stored in the memory 820 or on the storage device 830 to display graphical information for a user interface on the input/output device 840.

The memory 820 stores information within the system 800. In one implementation, the memory 820 is a computer-readable medium. In one implementation, the memory 820 is a volatile memory unit. In another implementation, the memory 820 is a non-volatile memory unit. The storage device 830 is capable of providing mass storage for the system 800. In one implementation, the storage device 830 is a computer-readable medium. In various different implementations, the storage device 830 may be a floppy disk device, a hard disk device, an optical disk device, or a tape device. The input/output device 840 provides input/output operations for the system 800. In one implementation, the input/output device 840 includes a keyboard and/or pointing device. In another implementation, the input/output device 840 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for fine-grain opinion mining of a corpus of computer-readable text, the method being executed by one or more processors and comprising:
receiving input data comprising a set of sentences, each sentence comprising computer-readable text as a sequence of tokens;
providing a memory network with coupled attentions (MNCA), the coupled attentions comprising an aspect attention and an opinion attention that are coupled by tensor operators for each sentence in the set of sentences;
processing the input data through the MNCA to identify a set of aspect terms, and a set of opinion terms, and simultaneously assign a category to each aspect term and each opinion term from a set of categories;
outputting the set of aspect terms with respective categories, and the set of opinion terms with respective categories.

2. The method of claim 1, wherein the tensor operators model complex token interactions.

3. The method of claim 1, wherein the aspect attention provides a likelihood that each token of a respective sentence is an aspect term, and the opinion attention provides a likelihood that each token of the respective sentence is an opinion term.

4. The method of claim 1, wherein each of the aspect attention and the opinion attention learns a prototype vector, a token-level feature vector, and a token-level attention score for each word in a sentence, the token-level feature vector and the token-level attention score representing an extent of correlation between each token and the prototype vector through a tensor operator.

5. The method of claim 1, wherein the tensor operators are provided as a set of aspect tensor operators, and a set of opinion tensor operators for each category in the set of categories.

6. The method of claim 1, wherein each token-level label comprises one of beginning of an aspect, inside of an aspect, beginning of an opinion, inside of an opinion, and none.

7. The method of claim 1, wherein a multi-task memory network (MTMN) comprises the MNCA, a shared tensor decomposition to model commonalities of syntactic relations among different categories by sharing the tensor parameters, context-aware multi-task feature learning to jointly learn features among categories by constructing context-aware task similarity matrices, and an auxiliary task to predict overall sentence-level category labels to assist token-level prediction tasks.

8. A non-transitory computer-readable storage medium coupled to one or more processors and having instructions stored thereon which, when executed by the one or more processors, cause the one or more processors to perform operations for fine-grain opinion mining of a corpus of computer-readable text, the operations comprising:
receiving input data comprising a set of sentences, each sentence comprising computer-readable text as a sequence of tokens;
providing a memory network with coupled attentions (MNCA), the coupled attentions comprising an aspect attention and an opinion attention that are coupled by tensor operators for each sentence in the set of sentences;
processing the input data through the MNCA to identify a set of aspect terms, and a set of opinion terms, and simultaneously assign a category to each aspect term and each opinion term from a set of categories;
outputting the set of aspect terms with respective categories, and the set of opinion terms with respective categories.

9. The computer-readable storage medium of claim 8, wherein the tensor operators model complex token interactions.

10. The computer-readable storage medium of claim 8, wherein the aspect attention provides a likelihood that each token of a respective sentence is an aspect term, and the opinion attention provides a likelihood that each token of the respective sentence is an opinion term.

11. The computer-readable storage medium of claim 8, wherein each of the aspect attention and the opinion attention learns a prototype vector, a token-level feature vector, and a token-level attention score for each word in a sentence, the token-level feature vector and the token-level attention score representing an extent of correlation between each token and the prototype vector through a tensor operator.

12. The computer-readable storage medium of claim 8, wherein the tensor operators are provided as a set of aspect tensor operators, and a set of opinion tensor operators for each category in the set of categories.

13. The computer-readable storage medium of claim 8, wherein each token-level label comprises one of beginning of an aspect, inside of an aspect, beginning of an opinion, inside of an opinion, and none.

14. The computer-readable storage medium of claim 8, wherein a multi-task memory network (MTMN) comprises the MNCA, a shared tensor decomposition to model commonalities of syntactic relations among different categories by sharing the tensor parameters, context-aware multi-task feature learning to jointly learn features among categories by constructing context-aware task similarity matrices, and an auxiliary task to predict overall sentence-level category labels to assist token-level prediction tasks.

15. A system, comprising:
a computing device; and
a computer-readable storage device coupled to the computing device and having instructions stored thereon which, when executed by the computing device, cause the computing device to perform operations for fine-grain opinion mining of a corpus of computer-readable text, the operations comprising:
receiving input data comprising a set of sentences, each sentence comprising computer-readable text as a sequence of tokens;
providing a memory network with coupled attentions (MNCA), the coupled attentions comprising an aspect attention and an opinion attention that are coupled by tensor operators for each sentence in the set of sentences;
processing the input data through the MNCA to identify a set of aspect terms, and a set of opinion terms, and simultaneously assign a category to each aspect term and each opinion term from a set of categories;
outputting the set of aspect terms with respective categories, and the set of opinion terms with respective categories.

16. The system of claim 15, wherein the tensor operators model complex token interactions.

17. The system of claim 15, wherein the aspect attention provides a likelihood that each token of a respective sentence is an aspect term, and the opinion attention provides a likelihood that each token of the respective sentence is an opinion term.

18. The system of claim 15, wherein each of the aspect attention and the opinion attention learns a prototype vector, a token-level feature vector, and a token-level attention score for each word in a sentence, the token-level feature vector and the token-level attention score representing an extent of correlation between each token and the prototype vector through a tensor operator.

19. The system of claim 15, wherein the tensor operators are provided as a set of aspect tensor operators, and a set of opinion tensor operators for each category in the set of categories.

20. The system of claim 15, wherein each token-level label comprises one of beginning of an aspect, inside of an aspect, beginning of an opinion, inside of an opinion, and none.
